(19) United States
(12) Patent Application Publication
(10) Pub. No.: US 2012/0134846 A1
(43) Pub. Date: May 31, 2012

(54) WIND TURBINE GENERATOR

(75) Inventors: Shinsuke SATO, Tokyo (JP); Daisuke NAKAO, Tokyo (JP); Shigenori SUEMORI, Tokyo (JP); Yoshito ANDO, Tokyo (JP)

(73) Assignee: MITSUBISHI HEAVY INDUSTRIES, LTD., Tokyo (JP)

(21) Appl. No.: 13/343,379

(22) Filed: Jan. 4, 2012

(30) Foreign Application Priority Data
Nov. 29, 2010 (JP) 2010-265677

(51) Int. Cl. F03D 11/00

(52) U.S. Cl. 416/97 R

(57) ABSTRACT

Provided is a wind turbine generator that prevents an increase of weight of a wind turbine blade and a reduction in ventilation efficiency and that realizes good ventilation cooling of a rotor head with a simple structure. The wind turbine generator includes: a hollow interior space formed in a wind turbine blade; an exhaust path provided through a wind-turbine-blade forming member at a tip end of the wind turbine blade or in a vicinity of the tip end, so as to allow the interior space to communicate with an outside of the wind turbine blade; and an opening that allows the interior space to communicate with a rotor head main body. Ventilation cooling inside the rotor head main body is performed by using a pressure difference between the tip end of the wind turbine blade and the rotor head main body, produced by a rotation of the wind turbine blade.

### TECHNICAL FIELD

The present invention relates to a wind turbine generator in which devices, such as a control panel, are installed in a rotor head, and particularly, to a wind turbine generator that performs ventilation and cooling of the inside of the rotor head.

### BACKGROUND ART

A wind turbine generator (hereinafter, also referred to as “wind turbine”) is an apparatus in which a rotor head having wind turbine blades rotates upon receiving wind force, and power is generated by a generator driven by increasing the speed of this rotation by a gear box. General wind turbine blades are made of fiber reinforced plastic (FRP).

The above-described rotor head is attached to an end portion of a nacelle, which is capable of yawing, provided on a wind turbine tower (hereinafter, referred to as “tower”) and is supported so as to be capable of rotating about a substantially horizontal rotational axis.

In the rotor head of the wind turbine generator, for example, a pitch cylinder, an accumulator, or a pitch motor constituting a pitch driving system for the wind turbine blades is provided as a general configuration. Furthermore, in the rotor head of the wind turbine generator, a control panel that includes a programmable logic controller (PLC) and a communication device for communicating with the nacelle is installed as a control section for controlling the operation of this control system.

The rotor head has a structure in which the outer periphery of a rotor head main body, which is generally made of cast iron in many cases, is covered with a head cover made of plastic. Furthermore, a plurality of manholes are provided in the rotor head main body because a worker needs to go in and out of the rotor head main body to perform maintenance work etc.

In the following description, “in the rotor head” is intended to specifically mean “in the rotor head main body”.

In the rotor head of the wind turbine generator, since the temperature is increased by heat generated when various devices are operated, it is necessary to cool the inside of the rotor head by discharging the heat to the outside.

As the simplest method for cooling the inside of the rotor head, it is conceivable to introduce cool air (outside air) from the outside to cool the internal devices, and to discharge to the outside high-temperature air (inside air) whose temperature has been increased by the heat generated inside. Specifically, it is necessary to replace the high-temperature inside air with low-temperature outside air by introducing the outside air to the inside of the rotor head.

A conventional technology that has been proposed for cooling the inside of the rotor head by replacing inside air with outside air is a technology in which outside air is supplied to the rotor head, and high-temperature inside air is discharged to the outside from a blade tip end, thereby keeping the temperature of air in the rotor head low (see PTL 1, for example).

### CITATION LIST

### Patent Literature

{PTL 1} US Patent Application Publication No. 2009/0060748

### SUMMARY OF INVENTION

### Technical Problem

In the above-described PTL 1, a special exhaust path is provided in the wind turbine blade in order to discharge air in the rotor head to the outside from an opening provided at the blade tip end. This exhaust path is a path formed of a pipe that connects the rotor head to the blade tip end, and thus, the diameter of the pipe is increased when a sufficient path cross-sectional area is ensured for the exhaust path. A problem that arises as a result is an increase in the weight of the rotor head and the wind turbine blade, which rotate.

On the other hand, when the path cross-sectional area of the exhaust path is minimized in order to suppress an increase in weight, the pressure loss of the exhaust path is increased to cause a reduction in ventilation efficiency, which is not desirable.

In this way, to perform ventilation cooling by providing, in the wind turbine blade, the exhaust path that connects the rotor head to the opening provided at the blade tip end, it is desired to resolve the above-described contradictory problems of an increase in the weight of the wind turbine blade and a reduction in ventilation efficiency.

Furthermore, in the conventional structure having the opening provided at the blade tip end, upon receiving a centrifugal force produced by the rotation of the wind turbine blade, foreign matter (hydraulic oil, lubricant oil, an adhesive agent, and FRP fibers) in the blade may be discharged to the outside of the blade together with air. In particular, when hydraulics is used for pitch control of the wind turbine blade, such discharge of the foreign matter is not favorable for the environment where the wind turbine generator is installed. Therefore, appropriate measures are desired.

The present invention has been made to solve the above-described problems, and an object thereof is to provide a wind turbine generator capable of resolving the problems of an increase in the weight of the wind turbine blade and a reduction in ventilation efficiency and of realizing good ventilation cooling of the rotor head with a simple structure.

### Solution to Problem

In order to solve the above-described problems, the present invention employs the following solutions.

According to a first aspect, the present invention provides a wind turbine generator in which a rotor head that rotates when wind turbine blades receive wind force drives a generator provided in a nacelle to generate power; the nacelle is provided at a top end of a tower provided upright on a foundation; and heat generating devices, such as a control panel, are installed in a rotor head main body of the rotor head, the wind turbine generator comprising a hollow interior space formed in each of the wind turbine blades along substantially the entire length of the wind turbine blade; an exhaust path provided through a wind-turbine-blade forming member at a tip end of the wind turbine blade or in a vicinity of the tip end, so as to allow the interior space to communicate with an outside of the wind turbine blade; and an opening that allows the interior space to communicate with the rotor head main body, wherein ventilation cooling of an inside of the rotor head main body is performed by using a difference in pressure between the tip end of the wind turbine blade and the rotor head main body, produced by a rotation of the wind turbine blade (first aspect).

According to the wind turbine generator of the first aspect of the present invention, the wind turbine generator includes the hollow interior space formed in each of the wind turbine blades along substantially the entire length of the wind turbine blade; the exhaust path provided through the wind-turbine-blade forming member at the tip end of the wind turbine blade or in the vicinity of the tip end, so as to allow the interior space to communicate with the outside of the wind turbine blade; and the opening that allows the interior space to communicate with the rotor head main body. Ventilation cooling of the inside of the rotor head main body is performed by using the difference in pressure between the tip end of the wind turbine blade and the rotor head main body, produced by the rotation of the wind turbine blade. Therefore, ventilation cooling of the inside of the rotor head can be performed with a simple structure requiring no power. In this case, since ventilation cooling is performed by using, as an air path, the interior space of the wind turbine blade having a wide cross-sectional area except for the exhaust path provided at the tip end of the wind turbine blade or in the vicinity of the tip end, it is possible to minimize an increase in the weight of the wind turbine blade and to perform efficient ventilation cooling with a low pressure loss.

An ordinary wind turbine blade is a hollow-structured fiber-reinforced-plastic machined part in which a reinforcing rib is provided, and approximately 90% of the blade cross-sectional area is space.

In the first aspect of the present invention, it is preferable that a foreign-matter collecting member for removing foreign matter flowing together with air be attached to the opening (second aspect). Thus, the foreign matter in the rotor head main body, such as lubricant oil, can be prevented from entering the interior space of the wind turbine blade.

In the first and second aspects of the present invention, it is preferable that the exhaust path be formed of a short pipe that penetrates the tip end of the wind turbine blade (third aspect). Thus, an increase in weight caused by forming the exhaust path can be minimized. In this case, the short pipe can be formed of a lightweight polyvinyl-chloride pipe, for example, and can have a small diameter.

It is preferable that the exhaust path be provided with a flow path control member that prevents an airflow from flowing straight from the interior space to an inlet opening of the exhaust path (fourth aspect). Thus, foreign matter, such as an adhesive agent and FRP fibers, generated in the interior space of the wind turbine blade is unlikely to flow out.

It is preferable that the flow path control member serve as a collecting and draining member for rainwater entering from the exhaust path (fifth aspect).

In the first aspect of the present invention, it is preferable that the exhaust path be provided through a blade surface in the vicinity of the tip end of the wind turbine blade; and a flow path control member that curves an air path connecting the interior space to an opening of the exhaust path and that defines a clearance dimension for the air path be provided (sixth aspect). Since the exhaust path opens laterally, rainwater is unlikely to enter the blade; and, since the exhaust path is provided with the flow path control member, foreign matter, such as an adhesive agent and FRP fibers, generated in the interior space of the wind turbine blade is unlikely to flow out.

In this case, it is preferable that the clearance dimension for the air path be set such that a ratio (Fω/Fd) of a centrifugal force (Fω) acting on particles to a drag (Fd) that the particles receive from airflow becomes 1 or more (Fω/Fd≧1) (seventh aspect). Thus, particle-like foreign matter is unlikely to flow out.

Furthermore, in the second aspect of the present invention, it is preferable that a temperature in the rotor head main body be monitored, and, when a high temperature having a predetermined value or higher is detected, this is judged to be timing for maintenance of the foreign-matter collecting member (eight aspect). Thus, it is possible to reliably obtain information about timing for maintenance of the foreign-matter collecting member.

### Advantageous Effects of Invention

According to the present invention, since good ventilation efficiency can be obtained with a structure having a small flow path resistance as well as causing almost no increase in the weight of the wind turbine blade, it is possible to provide a wind turbine generator capable of realizing good ventilation cooling of the inside of the rotor head with a simple structure.

Furthermore, foreign matter generated in the rotor head main body or the interior space of the wind turbine blade can be prevented from being discharged to the outside of the blade together with air, from the exhaust path open at the tip end of the wind turbine blade or in the vicinity of the tip end thereof, upon receiving the centrifugal force produced by the rotation of the wind turbine blade.

### BRIEF DESCRIPTION OF DRAWINGS

FIGS. 1A and 1B are views showing a wind turbine generator according to a first embodiment of the present invention; FIG. 1A is a view showing example inner structures of a rotor head main body and a wind turbine blade according to the first embodiment; and FIG. 1B is a perspective view of the wind turbine blade seen from the inside of the rotor head main body shown in FIG. 1A.

FIG. 2 is a graph showing ventilation cooling characteristics (the negative pressure level and the total flow rate) obtained by an increase in the rotating speed, in which the horizontal axis indicates the rotating speed of the wind turbine blade and the rotor head.

FIGS. 3A and 3B show a first modification of the example inner structure of the wind turbine blade shown in FIG. 1A; FIG. 3A is a view showing an example inner structure of the wind turbine blade; and FIG. 3B is a perspective view showing an example structure of an opening provided with a foreign-matter collecting member.

FIG. 4 is a view showing an example inner structure of a wind turbine blade according to a second embodiment, as one embodiment of the wind turbine generator of the present invention.

FIG. 5 is a view for explaining the operation of the embodiment shown in FIG. 4.

FIG. 6 shows the relationship between a clearance S and centrifugal force/drag, in three types of wind turbine blades having different blade lengths, for predicting the outflow of particles of 1 cm or more, in the structure of the embodiment shown in FIG. 5.

FIG. 7 is an outline view showing the outline of a wind turbine generator.

### DESCRIPTION OF EMBODIMENTS

A wind turbine generator according to one embodiment of the present invention will be described below with reference to the drawings.

### First Embodiment

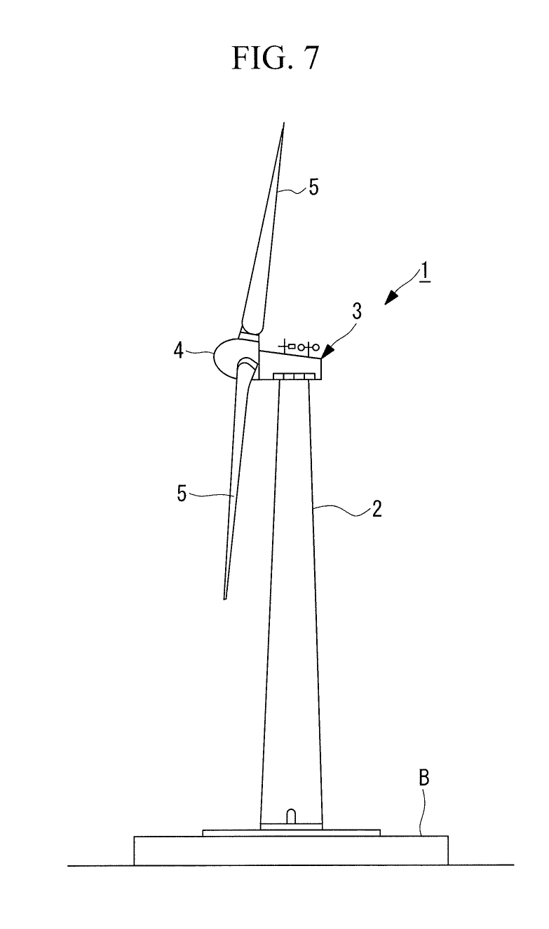

As shown in FIG. 7, a wind turbine generator 1 has a wind turbine tower (hereinafter, referred to as “tower”) 2 provided upright on a foundation B, a nacelle 3 provided on the top end of the tower 2, and a rotor head 4 provided on the front end of the nacelle 3 and supported so as to be capable of rotating about a substantially horizontal rotational axis.

A plurality of (for example, three) wind turbine blades 5 are attached to the rotor head 4 in a radiating pattern around the rotational axis of the rotor head 4. With this structure, the force of wind striking the wind turbine blades 5 from the direction of the rotational axis of the rotor head 4 is converted to mechanical power for rotating the rotor head 4 about the rotational axis.

An anemometer that measures a surrounding wind speed value and an anemoscope that measures the wind direction are provided at appropriate positions (for example, upper positions) on the outer periphery of the nacelle 3.

Specifically, in the wind turbine generator 1, the rotor head 4, which rotates about the substantially horizontal rotational axis when the wind turbine blades 5 receive the force of wind, drives a generator (not shown) provided in the nacelle 3 to generate power, and the nacelle 3 is provided on the top end of the tower 2 provided upright on the foundation B in a manner allowing yawing thereof.

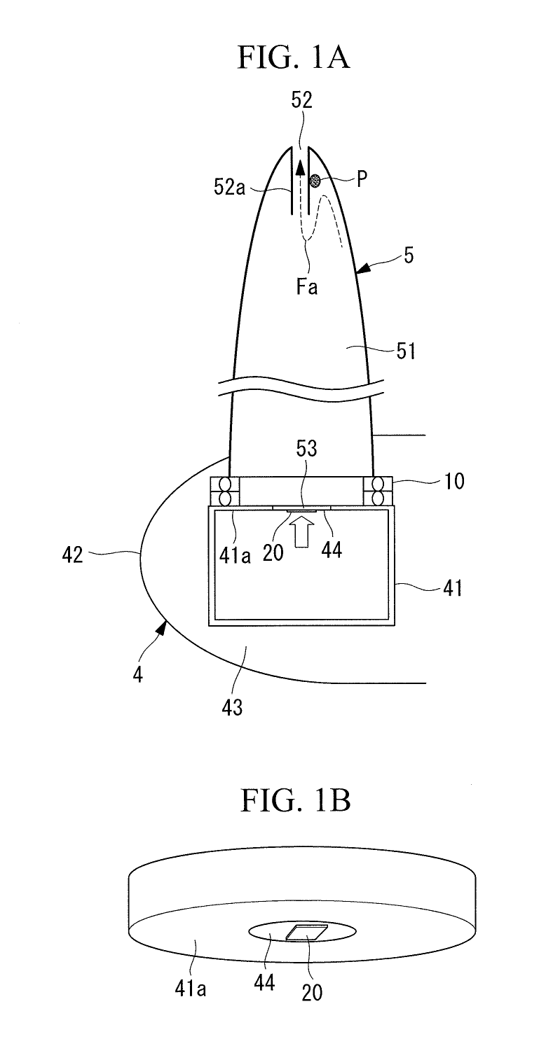

As shown in FIG. 1A, for example, the rotor head 4 is provided with a rotor head main body 41 and a head cover 42. The rotor head main body 41 is a hollow molded part, and the outer periphery of the rotor head main body 41 is covered with the head cover 42, which is made of plastic, so as to form a space portion 43 around the rotor head main body 41.

For example, hydraulic devices (not shown), such as a pitch cylinder, a pitch motor, and an accumulator, are provided in the rotor head main body 41 as system components for performing pitch control by using the hydraulic pressure of the wind turbine blades 5. Furthermore, electrical devices (not shown), such as a control panel that includes a programmable logic controller (PLC) and a communication device for communicating with the nacelle, are installed in the rotor head main body 41 as a control section for controlling the operation of the pitch control. Such hydraulic devices and electrical devices generate heat in the rotor head, together with driving parts (not shown) having sliding parts, such as main bearings.

A plurality of manholes are provided on the rotor head main body 41, which are used for workers to go in and out and to carry in and out devices installed inside at the time of construction or maintenance of the wind turbine generator 1, such as a head manhole (not shown) that is provided at the tip side and a blade-side manhole 44 that is formed so as to communicate with the interior space of the wind turbine blade 5. As the blade-side manhole 44 of this embodiment, a maintenance hatch provided on a wind-turbine-blade attachment surface 41a of the rotor head main body 41 is used, for example, for the maintenance of a blade slewing ring bearing 10 that allows adjustment of the pitch angle of the wind turbine blade 5.

Furthermore, an inlet port (not shown) that communicates, via the space portion 43, with an outside-air introducing port (not shown) provided on the nacelle 3 is provided at an appropriate position of the rotor head main body 41.

In order to perform ventilation cooling of the inside of the rotor head main body 41, the wind turbine generator 1 of this embodiment includes a hollow interior space 51 formed in each of the wind turbine blades 5 along substantially the entire length of the wind turbine blade 5, an exhaust path 52 that is provided through a wind-turbine-blade forming member at the tip end of the wind turbine blade 5 so as to allow the interior space 51 to communicate with the outside of the wind turbine blade 5, and an opening 53 that allows the inside of the rotor head main body 41 to communicate with the interior space 51. The interior space 51, the exhaust path 52, and the opening 53 form a ventilation-cooling-air path used to perform ventilation cooling of the inside of the rotor head main body 41 with use of the difference in pressure between the tip end side of the wind turbine blade 5 and the inside of the rotor head main body 41, produced by the rotation of the rotor head 4.

Specifically, in the rotor head main body 41, since low-temperature outside air is introduced from the inlet port at the same time as when high-temperature air is discharged to the outside through the above-described ventilation-cooling-air path, it is possible to suppress an increase in temperature through ventilation cooling, in which high-temperature air is replaced with low-temperature air to perform cooling.

The interior space 51 occupies a large part of the ventilation-cooling-air path, which connects the opening 53 provided at the base side of the wind turbine blade 5 to the exhaust path 52 provided at the tip end of the wind turbine blade 5. Specifically, the wind turbine blade 5 of this embodiment is a hollow-structured FRP machined part in which a reinforcing rib is provided. Therefore, the interior space 51, which connects the opening 53 provided at the base side to the exhaust path 52 provided at the tip end side and also which serves as an air path having a large cross-sectional area percentage, is formed in the wind turbine blade 5. Since the interior space 51 is a large space occupying approximately 90% of the blade cross-sectional area of the wind turbine blade 5, the flow path resistance of the airflow caused by ventilation cooling is small.

The exhaust path 52 opens at the tip end of the wind turbine blade 5 to allow the interior space 51 to communicate with the outside of the wind turbine blade 5, that is, to allow the interior space 51 to communicate with outside air in the outside of the wind turbine blade 5, to discharge air in the rotor head main body 41 to the outside. Although there are no particular limitations to the exhaust path 52, as long as an opening is provided through the blade forming member at the tip end of the wind turbine blade 5; however, it is desirable for the opening to have as small a diameter as possible, in consideration of the strength of the wind turbine blade 5, rain infiltration, etc. However, in consideration of the flow path resistance, it is desirable for the opening to have as large a diameter as possible. Therefore, an optimum value can be adopted in consideration of the priority corresponding to the conditions.

Regarding the exhaust path 52 of this embodiment, a short pipe 52a that is embedded in the blade forming member so as to penetrate the tip end of the wind turbine blade 5 is used. Specifically, when the wind turbine blade 5, made of FRP, is machined, the exhaust path 52 is obtained by embedding and fixing the short pipe 52a, such as a polyvinyl chloride pipe, which is used for the exhaust path 52, at the blade tip end. In this case, the short pipe can be formed of a lightweight polyvinyl chloride pipe, for example, and can have a small diameter.

The short pipe 52a, used for the exhaust path 52, is embedded so as to open and form substantially the same surface as the blade surface without protruding from the blade surface, at the outer periphery side of the wind turbine blade 5, and is embedded so as to protrude to have an appropriate length at the side of the interior space 51. In this case, this protruding portion should have a sufficient length to form a space in which foreign matter P generated in the interior space 51, such as FRP fibers and an adhesive agent, rolls over along the wall surface of the interior space 51, thereby preventing them from smoothly flowing to the outside of the blade from the outlet opening of the exhaust path 52, in other words, enough to form a space to separately trap the foreign matter P at the blade tip end side in the interior space 51 by making exhaust air turn around, as indicated by an arrow Fa in FIG. 1A, and flow.

In this way, when the short pipe 52a, which is made of a lightweight polyvinyl-chloride pipe, is used for the exhaust path 52, since the short pipe 52a has a short length and a small diameter, an increase in weight caused by providing the short pipe 52a can be minimized. Therefore, with use of the interior space 51, which does not lead to an increase in weight, it is possible to minimize an increase in the weight of the wind turbine blade 5 caused by forming the ventilation-cooling-air path.

The opening 53 is a communicating port provided in the blade-side manhole 44 between the rotor head main body 41 and the interior space 51. For example, a filter 20 is attached to the opening 53 as a foreign-matter collecting member for removing foreign matter flowing together with air.

With the filter 20 being attached to the opening 53, foreign matter, such as lubricant oil and hydraulic oil, generated in the rotor head main body 41 can be prevented from entering the interior space 51 of the wind turbine blades 5 together with air.

In particular, in the wind turbine generator 1, which performs hydraulic pitch control, even if hydraulic oil etc. leak out unexpectedly, providing the filter 20 prevents them from being discharged from the tip end of the wind turbine blade 5 together with airflow used for ventilation cooling. Specifically, the opening 53 provided with the filter 20 allows air to flow and traps foreign matter, such as particles and lubricant oil, to prevent them from passing therethrough.

The foreign-matter collecting member to be attached to the opening 53 is not limited to the above-described filter 20, and, for example, a louver or a combination of the filter 20 and a louver can be attached thereto.

In this way, in the wind turbine generator 1, in which the rotor head 4, which rotates when the wind turbine blades 5 receive wind, drives the generator provided in the nacelle 3 to generate power, the nacelle 3 is provided on the top end of the tower 2 provided upright on the foundation, and in-head devices (heat generating devices) are provided in the rotor head main body 41 of the rotor head 4, the ventilation-cooling-air path is formed by the interior space 51, the exhaust path 52, and the opening 53; and ventilation cooling, in which high-temperature air in the rotor head main body 41 is sucked and discharged to the outside, is performed by using the difference in pressure produced when the wind turbine blades 5 rotate by receiving wind, where the pressure at the side of the opening 53 that opens at the base end side of the wind turbine blade 5 becomes lower than that in the rotor head main body 41.

Since the ventilation cooling uses the difference in pressure produced by the rotation of the wind turbine blades 5, ventilation cooling of the inside of the rotor head main body 41 can be performed with a simple structure requiring no power.

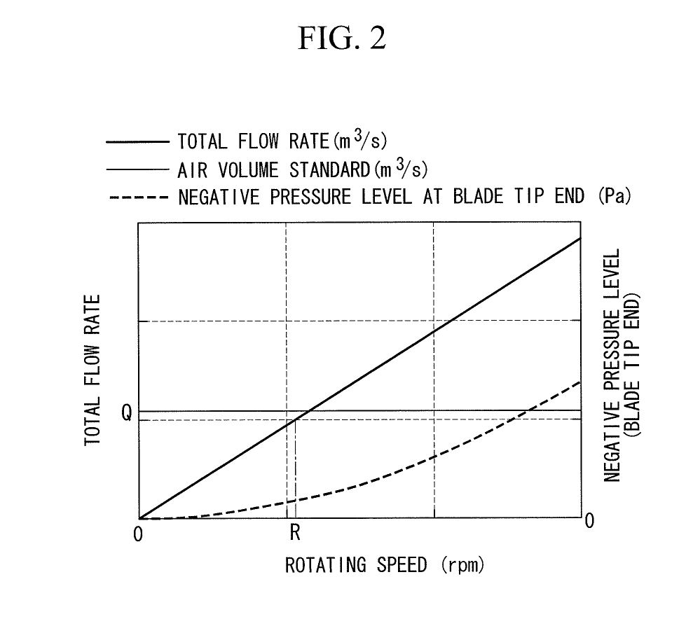

FIG. 2 is a graph showing the rotating speed of the rotor head 4 (the rotating speed of the wind turbine blades 5) and ventilation cooling characteristics (the negative pressure level and the total flow rate) obtained by an increase in the rotating speed. In this case, as the ventilation characteristics, the negative pressure level at the opening at the tip end of the wind turbine blade 5, that is, the outlet opening of the exhaust path 52, and the total flow rate of air used for ventilation cooling are shown in the graph, as examples.

From this graph, as the rotating speed increases, the relative outside-air flow speed at the tip end of the wind turbine blade is increased, and therefore, the negative pressure level at the outlet opening of the exhaust path 52 is increased. As a result, the difference in pressure is increased as the negative pressure level is increased, and the amount of air for ventilation cooling flowing through the interior space 51 and flowing out from the outlet opening is also increased. Thus, efficient ventilation cooling is performed. In the example shown in the graph, the total flow rate Q required for the ventilation cooling of the expected amount of generated heat is obtained at a rotating speed R of the wind turbine blades 5 or more.

In such ventilation cooling, since the interior space 51, occupying a large part of the ventilation-cooling-air path, is a large space occupying approximately 90% of the blade cross-sectional area of the wind turbine blade 5, the flow path resistance of airflow for ventilation cooling is small. Specifically, the wind turbine blade 5 of this embodiment is a hollow-structural FRP machined part, having the reinforcing rib provided therein. Therefore, the interior space 51, which connects the base to the tip end and has a large cross-sectional area percentage, is formed in the wind turbine blade 5. Thus, ventilation cooling is performed by using, as an air path, the interior space 51 of the wind turbine blades 5, which has a large cross-sectional area except for the opening 53 provided at the base end of the wind turbine blade 5. Thus, it is possible to minimize an increase in the weight of the wind turbine blade 5 and to perform efficient ventilation cooling with a low pressure loss.

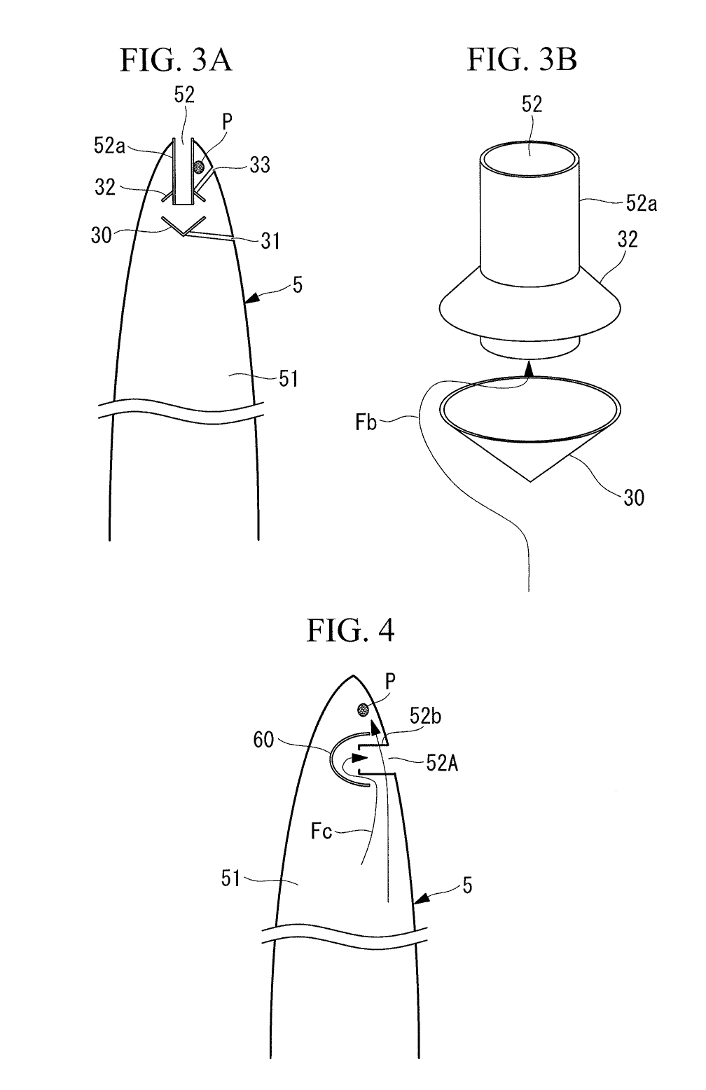

For example, as in a first modification shown in FIGS. 3A and 3B, the above-described exhaust path 52 includes an umbrella-like baffle 30 as a flow path control member in order to prevent the airflow from flowing straight toward the inlet opening of the exhaust path 52 from the interior space 51. The umbrella-like baffle 30 is supported on the wall surface of the wind-turbine-blade forming member, which forms the interior space 51, by using a supporting member (not shown). Specifically, the umbrella-like baffle 30 is provided at a position a predetermined distance away from the inlet opening of the exhaust path 52 toward the rotor head main body 41, so as to cover the inlet opening of the exhaust path 52 when the inlet opening is seen from the rotor head main body 41, to cause the airflow to flow out from the exhaust path 52 and turn around (see an arrow Fb in FIG. 3B).

Since the foreign matter P, such as an adhesive agent and FRP fibers, generated in the interior space 51 of the wind turbine blade 5 has a larger mass than the airflow, by providing the umbrella-like baffle 30, the foreign matter P separates from the airflow due to the turnaround of the airflow and thus, is unlikely to flow to the outside of the wind turbine blade 5.

Furthermore, the above-described umbrella-like baffle 30 can receive and collect rainwater entering from the exhaust path 52 when the wind turbine blade 5 is positioned at the upper side, in other words, when the outlet opening of the exhaust path 52 is directed toward the sky, in particular, when the wind turbine blade 5 is stopped. Then, if a drainage path 31 is provided for the umbrella-like baffle 30 to drain the collected rainwater to the outside of the wind turbine blade 5, it is possible to prevent the collected rainwater from overflowing from the umbrella-like baffle 30 and dripping on the rotor head main body 41, particularly, when the wind turbine blade 5 is stopped while facing upward.

If a similar umbrella-like member 32 is attached also to a portion on the outer periphery of the short pipe 52a protruding toward the interior space 51, and a drainage path 33 is provided for the umbrella-like member 32, it is possible to receive rainwater collected by the umbrella-like baffle 30 even when the wind turbine blade 5 is rotated and to actively drain it to the outside using the centrifugal force produced by the rotation of the rotor head 4.

### Second Embodiment

Next, a wind turbine generator according to a second embodiment of the present invention will be described with reference to FIGS. 4 to 6. Identical reference symbols are assigned to the same components as those of the above-described embodiment, and a description thereof will be omitted.

In this embodiment, an exhaust path 62 provided through the wind-turbine-blade forming member in the vicinity of the tip end of the wind turbine blade 5 is adopted instead of the exhaust path 52 of the above-described embodiment, provided at the tip end of the wind turbine blade 5. Specifically, the exhaust path 62 of this embodiment opens at a side-surface portion of the wind turbine blade 5 by means of a short pipe 52b, in the vicinity of the tip end of the wind turbine blade 5.

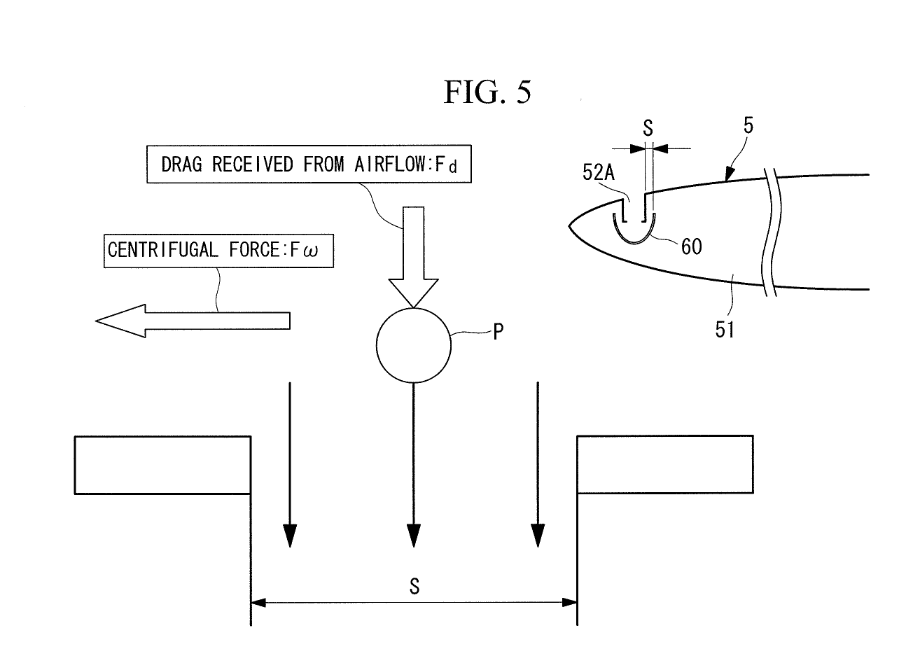

In the exhaust path 62, provided through the blade surface in the vicinity of the tip end of the wind turbine blade 5, an air path connecting the interior space 51 to the opening of the exhaust path is curved to make the airflow turn around (see an arrow Fc in FIG. 4). A flow path control member 60 is provided for the exhaust path 62 so as to define a clearance dimension S shown in FIG. 5 for the air path.

The flow path control member 60 shown in the figure is a bowl-shaped member mounted at a predetermined distance away from an inlet opening of the exhaust path 62. The clearance dimension S is defined as the face-to-face distance between the outer periphery of the short pipe 52b and the inner surface of the flow path control member 60. A portion of the air path having the clearance dimension S is the narrowest.

The exhaust path 62 has a structure in which rainwater is unlikely to enter the interior space 51 of the blade because the exhaust path 62 opens laterally with respect to the axis direction of the wind turbine blade 5. Furthermore, with the flow path control member 60 being provided, the foreign matter P, such as an adhesive agent and FRP fibers, generated in the interior space 51 of the wind turbine blade 5 is separated from the airflow when the flow direction is changed and, therefore, is unlikely to flow out to the outside of the wind turbine blade 5.

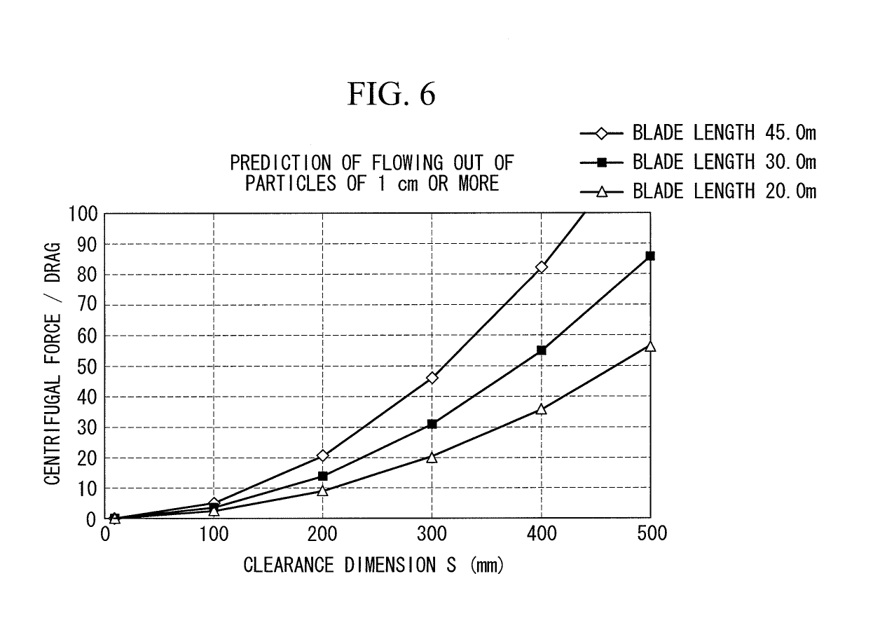

As shown in FIG. 6, when the ratio of the centrifugal force to the drag is small, the drag acting on particles is larger. Thus, the particles follow a trajectory along the airflow and are likely to flow out from the exhaust path 62. However, when the ratio of the centrifugal force to the drag is small, the centrifugal force acting on particles is larger. Thus, the particles do not follow a trajectory along the airflow but separate from the airflow. FIG. 6 shows the ratio (Fω/Fd) of the centrifugal force to the drag with respect to the clearance dimension S, in order to predict that particles of 1 cm or more flow out from the exhaust path 62, in three types of wind turbine blades 5 having different blade lengths.

Specifically, when the clearance dimension S is reduced, the flow speed is increased to increase the drag acting on the particles, and thus, the particles flown out together with the airflow for ventilation cooling. However, when the clearance dimension S is increased, the centrifugal force becomes dominant, and thus, the particles separate from the airflow for ventilation cooling and are accumulated at the blade tip end side of the interior space 51.

Thus, a preferable clearance dimension S for the air path, through which the particle-like foreign matter P is unlikely to flow out just needs to be set such that the ratio (Fω/Fd) of the centrifugal force (Fω) acting on the particles to the drag (Fd) that the particles receive from the airflow becomes 1 or more (Fω/Fd≧1).

In the above-described embodiments, the temperature in the rotor head main body 41 is monitored, and, when a high temperature having a predetermined value or more is detected, this is judged to be timing for maintenance of the filter 20, which is a foreign-matter collecting member. Specifically, since a temperature sensor is provided in the control panel (not shown) installed in the rotor head main body 41, when the temperature detected by the temperature sensor is equal to or higher than the predetermined value, it can be determined that sufficient ventilation cooling is not performed due to clogging of the filter 20 or other reasons. Therefore, since the need for maintenance, such as cleaning or replacement, of the filter 20 can be recognized by outputting this temperature detection signal, it is possible to reliably obtain information about timing of maintenance of the foreign-matter collecting member. At this time, by taking into account whether it is determined from the rotating speed of the rotor head 4 that the total flow rate Q, which is required for ventilation cooling of the rotor head 4, has been obtained, it is possible to estimate the cause of an increase in temperature more accurately. Specifically, even if the temperature just reaches the predetermined value or more, when the rotor head 4 is not sufficiently rotated, and thus, the flow rate of cooling air does not reach the total flow rate Q, the clogging of the filter 20 is not identified as the cause of an increase in temperature. Conversely, if the temperature reaches the predetermined value or more while the rotor head 4 is rotating enough to obtain the total flow rate Q, it can be determined that this is due to the filter 20.

As described above, according to the above-described embodiments of the present invention, good ventilation efficiency can be obtained with a structure having small flow path resistance as well as almost no increase in the weight of the wind turbine blade 5. Therefore, ventilation cooling of the inside of the rotor head main body 41 of the rotor head 4 can be efficiently performed with a simple structure using no power.

Furthermore, the foreign matter P generated in the rotor head main body 41 or the interior space 51 of the wind turbine blade 5 can be prevented from being discharged to the outside of the blade together with air, from the exhaust path 52 that opens at the tip end of the wind turbine blade 5 or from the exhaust path 62 that opens in the vicinity of the tip end thereof, upon receiving the centrifugal force produced by the rotation of the wind turbine blade 5.

The present invention is not limited to the above-described embodiments, and appropriate changes can be made without departing from the scope thereof. For example, manholes provided at three positions or more can be used to form an inlet port and an exhaust port.

### REFERENCE SIGNS LIST

1 wind turbine generator
2 tower
3 nacelle
4 rotor head
5 wind turbine blade
10 blade slewing ring bearing
20 filter (foreign-matter collecting member)
30 umbrella-like baffle
31, 33 drainage path
32 umbrella-like member
41 rotor head main body
41a wind-turbine-blade attachment surface
42 head cover
43 space portion
51 interior space
52, 62 exhaust path
52a, 52b short pipe
53 opening
60 flow path control member

1. A wind turbine generator in which a rotor head that rotates when wind turbine blades receive wind force drives a generator provided in a nacelle to generate power; the nacelle is provided at a top end of a tower provided upright on a foundation; and heat generating devices, such as a control panel, are installed in a rotor head main body of the rotor head, the wind turbine generator comprising:
a hollow interior space formed in each of the wind turbine blades along substantially the entire length of the wind turbine blade;
an exhaust path provided through a wind-turbine-blade forming member at a tip end of the wind turbine blade or in a vicinity of the tip end, so as to allow the interior space to communicate with an outside of the wind turbine blade; and
an opening that allows the interior space to communicate with the rotor head main body,
wherein ventilation cooling of an inside of the rotor head main body is performed by using a difference in pressure between the tip end of the wind turbine blade and the rotor head main body, produced by a rotation of the wind turbine blade.

2. A wind turbine generator according to claim 1, wherein a foreign-matter collecting member for removing foreign matter flowing together with air is attached to the opening.

3. A wind turbine generator according to claim 1, wherein the exhaust path is formed of a short pipe that penetrates the tip end of the wind turbine blade.

4. A wind turbine generator according to claim 3, wherein the exhaust path is provided with a flow path control member that prevents an airflow from flowing straight from the interior space to an inlet opening of the exhaust path.

5. A wind turbine generator according to claim 4, wherein the flow path control member serves as a collecting and draining member for rainwater entering from the exhaust path.

6. A wind turbine generator according to claim 1,
wherein the exhaust path is provided through a blade surface in the vicinity of the tip end of the wind turbine blade; and
a flow path control member that curves an air path connecting the interior space to an opening of the exhaust path and that defines a clearance dimension for the air path is provided.

7. A wind turbine generator according to claim 6, wherein the clearance dimension for the air path is set such that a ratio (Fω/Fd) of a centrifugal force (Fω) acting on particles to a drag (Fd) that the particles receive from airflow becomes 1 or more (Fω/Fd≧1).

8. A wind turbine generator according to claim 2, wherein a temperature in the rotor head main body is monitored, and, when a high temperature having a predetermined value or higher is detected, this is judged to be timing for maintenance of the foreign-matter collecting member.
